(19) United States
(12) Patent Application Publication
(10) Pub. No.: US 2021/0190247 A1
(43) Pub. Date: Jun. 24, 2021

(54) Connection arrangement for forming a fluidic connection

(71) Applicant: NORMA Germany GmbH, Maintal (DE)

(72) Inventor: Sven-Bertil Andersson, Gnosjö Hillerstorp (SE)

(21) Appl. No.: 17/254,431

(22) PCT Filed: May 27, 2019
(86) PCT No.: PCT/EP2019/063642

§ 371 Date: Dec. 21, 2020

(30) Foreign Application Priority Data
Jun. 21, 2018 (DE) 10 2018 114 918.2

(51) Int. Cl. F16L 37/00; F16L 37/252

(52) U.S. Cl. CPC F16L 37/008; F16L 37/252

(57) ABSTRACT

The disclosure relates to a connection arrangement for forming a fluidic connection between a container and a fluid line. A wall element is arranged in or on a container wall of the container and has an opening. A tubular connection element has two sealing surfaces. The connection element has a sealing section at the end which is arranged around the circumference on the connection element and has an axially oriented sealing surface. The connection element has a second sealing surface around the circumference at an end opposite the sealing section. The connection element has a connection section in the region of the first sealing surface for introducing into the opening of the wall element and for connecting to the wall element.

The disclosure relates to a connecting arrangement for forming a fluid-conducting connection between a container and a fluid line, and also to a method for the fluid-conducting connection of a connecting element to a wall element.

Various possibilities for connecting a fluid line to a container are known. In particular, tubular connectors, which can receive a hose or a pipe at an end side, are used for this purpose. Connectors of this kind can be fastened to the container by means of a screw thread or a flange.

Furthermore, connectors are known which can be connected to a container in a materially bonded manner. The materially bonded connection can be produced by adhesive bonding, soldering or welding. As a further solution, it is known to configure the container integrally with the connector.

However, a problem with known connecting arrangements is an increased assembly effort and/or an increased production effort. An increased assembly effort may result from an awkward screwing operation or a subsequent materially bonded connection of the connector to the container. In this case, it is in particular necessary to carry out a plurality of work steps, which involve arranging and holding the connector at an installation position and subsequently screwing or adhesively bonding the connector to the container.

### SUMMARY

It is therefore an object of an embodiment of the disclosure to eliminate the disadvantages of the prior art and to provide a connecting arrangement which can be realized in a rapid manner and with a low assembly effort.

The disclosure, per an embodiment, relates to a connecting arrangement for forming a fluid-conducting connection between a container and a fluid line. The connecting arrangement comprises a wall element, which can be arranged in or on a container wall of the container and which has an opening, and a tubular connecting element having two sealing surfaces. The connecting element comprises, at an end side, a seal portion which is arranged circumferentially on the connecting element and which comprises an axially oriented sealing surface. At an end of the connecting element, said end being opposite the seal portion, a second sealing surface is formed on the circumference. According to an embodiment of the disclosure, the connecting element comprises, in the region of the first sealing surface, a connecting portion for insertion into the opening of the wall element and for connection to the wall element.

The connecting element, per an embodiment, makes it possible to provide an adapter which can be inserted rapidly into the wall element in a positionally fixed manner. In the inserted state, a fluid-tight connection is produced between the connecting element and the wall element. In particular, in the inserted state of the connecting element, the first sealing surface is axially pressed against a flat bearing surface of the wall element, as a result of which a fluid-tight sealing zone is formed. The first sealing surface can be embodied, for example, as a radially circumferential groove with an O-ring. The axially directed pressing force can be generated, for example, by a connecting element which comprises pressing ramps. As a result of a rotation of the connecting element in relation to the wall element, the seal portion can thus be tightened against the wall element. The connection between the connecting element and the wall element can be produced as a result of a rotational movement or as a result of an application of pressure. In this case, the connecting portion can form a positively locking, force-fitting or a frictionally locking connection with the wall element. The assembly effort can thus be reduced, since merely a movement sequence is required to assemble the connecting element on the wall element. This movement sequence, per an embodiment, can be effected with one positioning tool, as a result of which a tool change during the assembly can be omitted.

The wall element can comprise, per an embodiment, at least in certain regions, a thin-walled portion for receiving the connecting portion. In particular, the wall element can be attachable to a container wall or be designed as a region of a container wall. As an alternative, the wall element can be introducible into a cutout in a wall, such as, for example, a container wall, a wall of a room or of a vehicle body and the like, in a positively locking manner.

The connecting arrangement according to an embodiment of the disclosure can be used for the fluid-conducting connection of tanks or containers, as a secondary air supply, drainage line, transport line for, for example, oil or fuel, as a ventilation line and the like.

The connecting element is designed, per an embodiment, in a substantially rotationally symmetrical manner. The wall element can be producible by injection molding, metal casting, stamping and bending processes and the like. The connecting arrangement can hereby be produced and assembled with a repeatable and optimized quality.

According to an embodiment, the connecting portion can be connected to the wall element in a positively locking or force-fitting manner. In this way, a rapid assembly of the connecting element on the wall element can be realized. By way of example, the connecting portion of the connecting element can project through the opening of the wall element and latch or hook on the wall element. As an alternative or in addition, the connecting portion per an embodiment can be pressed into the opening of the wall element.

The connecting element, per an embodiment, can be assembled on the wall element in a rapid and efficient manner if the connecting portion of the connecting element and the opening of the wall element are designed as a bayonet closure. The connection can thus be realized by a plug-and-twist movement, wherein the connecting portion is plugged into the opening and subsequently locked on the wall element as a result of a rotation. A connecting arrangement designed in this way can be designed both as a releasable connection, or a connection which can no longer be subsequently released, between the connecting element and the wall element.

The connection, per an embodiment, is realized by way of a plug-and-twist movement: The two parts to be connected are placed in one another; approximately perpendicular to the plug-in direction, elongate elevations are attached in both parts at the connecting point. However, these elevations do not run all the way around, but are interrupted (otherwise it would not be possible to plug the parts into one another). Since the elevations then lie in a slightly oblique manner in the plane perpendicular to the plug-in direction, the two parts are pressed against one another as a result of a rotational movement. The bayonet closure thus operates like a thread. Sometimes (for example in the case of camera lenses), a catch is additionally used to secure the connection. As an alternative to moving the interlocking rails, it is also possible to use a correspondingly formed indentation on the one part and a bulge on the other part.

According to a further embodiment of the connecting arrangement, the opening of the wall element comprises at least one cutout for receiving at least one protrusion of the connecting portion. The connecting element can be locked on the wall element in a releasable or non-releasable manner as a result of a rotation of the connecting element in relation to the wall element along an axis of symmetry. At least one pressing ramp is arranged at an end side of the connecting portion, said pressing ramp generating an axially directed pressing force as a result of a rotation of the connecting element and pressing the seal portion against the wall element in order to form a fluid-tight connection. The opening comprises at least one cutout and at least one counter portion for interaction with the at least one pressing ramp. The cutouts and the counter portions are arranged in an alternating manner on the circumferential side of the opening. To implement a latching connection, the at least one pressing ramp can comprise a latching lug which can be coupled to the at least one cutout or the at least one counter portion in a positively locking manner. The connecting arrangement, per an embodiment, can be produced without adhesive bonding or welding if, in the connected state, a fluid-tight sealing zone can be formed between the seal portion of the connecting element and the wall element. The first sealing surface which is arranged on the seal portion and which faces the wall element can be configured, for example, by a flat seal or an O-ring.

According to a further embodiment of the connecting arrangement, the second sealing surface is configured to receive a fluid line. Here, the fluid line can be arranged on a portion of the connecting element, said portion being delimited circumferentially by the second sealing surface. The fluid line can be pushed directly onto the portion or can be connectable to the connecting element indirectly by way of a coupling portion. Additional fastening means, such as, for example, cable ties or hose clamps, can be used to fix or to secure the fluid line. In this way, it is possible to ensure an additional mechanical strength of the fluid line arranged on the connecting element.

The connecting arrangement can be used in a flexible and versatile manner if the container is a tank, a vessel, a room or at least one region of a vehicle body.

According to a further embodiment of the connecting arrangement, the second sealing surface is formed as an SAE connection, a VDA connection, a hose connector or a V2 connection. In this way, the connecting element can be producible independently of the wall element and can be usable in a manner adapted to a field of application of the connecting arrangement. In certain embodiments, differently designed fluid lines and coupling systems of fluid lines can hereby be couplable to the connecting element. Furthermore, differently formed connecting elements can be inserted, selectively or as desired, into a wall element.

The connecting element, per an embodiment, can be arranged on the wall element in a positionally fixed manner and in a manner secured against loosening if the connecting portion of the connecting element comprises at least one latching element for forming a latching connection to the wall element. In certain embodiments, the at least one latching element can be embodied as a latching lug in the region of a pressing ramp of the connecting portion. The latching lug can interact with a counter portion or a cutout of the opening of the wall element.

The assembly of the connecting element on the wall element can be simplified and accelerated if the tubular connecting element comprises, in an inner region, an inner profile for receiving a tool head in a rotationally secure manner. By way of example, the inner profile can be configured as an angular profile which is embodied correspondingly to a tool head. The profile can for example comprise a rectangular, triangular or a hexagonal inner profile. Furthermore, the inner profile can comprise axially running cutouts for receiving the tool head in a rotationally secure manner. The tool head can be inserted, at least in certain regions, into the inner region of the connecting element in a positively locking manner and can be used to assemble the connecting element.

The connecting arrangement, per an embodiment, can be producible in a versatile manner if the wall element can be recessed into a container wall of the container, is embodied as a portion of the container wall or can be connected to the container wall in a materially bonded manner. In certain embodiments, as a result of the connecting arrangement, it is possible to dispense with the use of a flange connection or a screw connection, as a result of which the connecting arrangement is designed in a space-saving manner.

The disclosure, per an embodiment, also relates to a method for the fluid-conducting connection of a connecting element to a wall element. In one step, a tool head is arranged in an inner region of the connecting element in a rotationally secure manner. The tool head is used to arrange the connecting element in an opening of the wall element in such a way that a connecting portion of the connecting element projects through the opening. Subsequently, the connecting element is rotated as a result of a rotational movement of the tool head relative to the wall element and is locked on the wall element.

As a result of the rotation of the connecting element, per an embodiment, pressing ramps of a connecting portion of the connecting element, said pressing ramps being inserted into the wall element through cutouts of the opening, interact with the wall element in a mechanical manner. A rotation of the connecting element leads to overlapping of the pressing ramps with counter portions of the opening or of the wall element and thus locking of the connecting element on the wall element.

The method according to an embodiment of the disclosure makes it possible to assemble the connecting element on the wall element in a simple and rapid manner. The movement sequences for this can be performed in an automated manner. The positioning of the connecting element in the opening and a subsequent rotation of the connecting element can be performed without a tool change.

The wall element and the connecting element can be composed of the same material or of different materials. In certain embodiments, the material used can be a plastic or a metal.

### BRIEF DESCRIPTION OF THE FIGURES

Further features, details and advantages of the disclosure become apparent from the phrasing of the claims and from the following description of embodiments with reference to the drawings, in which:

FIG. 1 shows an illustration of a wall element of a connecting arrangement according to the disclosure according to one embodiment,

FIG. 2 shows illustrations of connecting elements of the connecting arrangement according to an embodiment of the disclosure,

FIG. 3 shows a plan view of a tool for assembling the connecting element on the wall element,

FIG. 4 shows a schematic sectional illustration of the connecting arrangement,

FIG. 5 shows perspective illustrations of connecting elements according to the disclosure according to further embodiments and

FIG. 6 shows illustrations for illustrating the method according to an embodiment of the disclosure.

### DETAILED DESCRIPTION

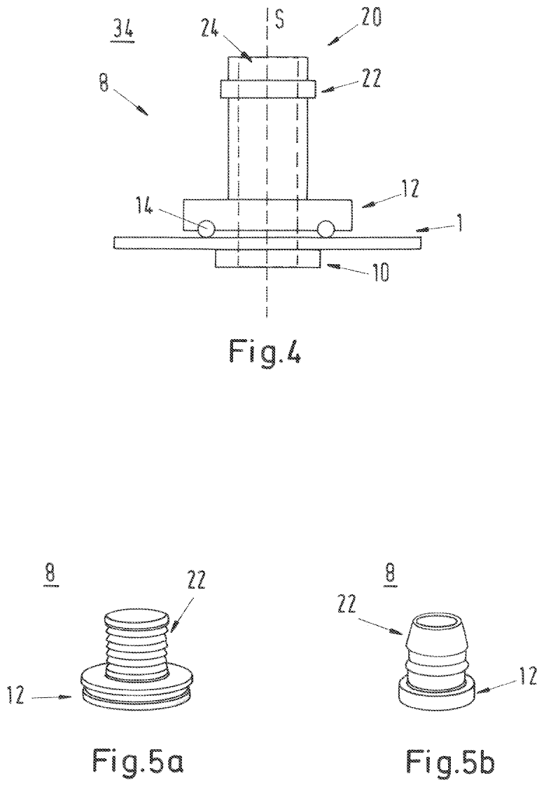

FIG. 1 shows a wall element 1 according to an embodiment of the disclosure of a connecting arrangement as illustrated in FIG. 4. The wall element 1 is of square form and comprises an opening 2 which extends through the wall element 1 in a centered manner. Three cutouts 4 are introduced on the circumferential side of the opening 2. A respective counter portion 6 is configured between the three cutouts. According to the embodiment, the cutouts 4 are uniformly or symmetrically distributed over the circumference. As an alternative, the at least one cutout 4 and the at least one counter portion 6 can be arranged in an asymmetrical manner on the opening 2.

The wall element 1 can be designed, for example, as a container wall. As an alternative, the wall element 1 can be positionable on a container wall or can be insertable into a container wall. In this case, the wall element 1 can be connectable to the container wall in a materially bonded or force-fitting manner.

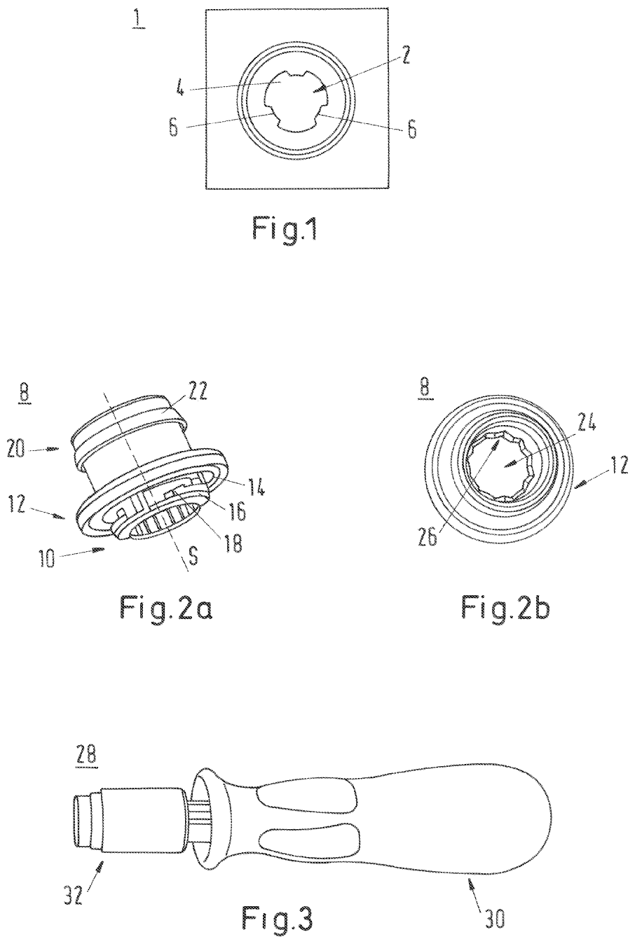

FIG. 2a and FIG. 2b show illustrations of a tubular connecting element 8 from different perspectives. The connecting element 8 is formed symmetrically substantially along an axis of symmetry S. The connecting element 8 comprises a connecting portion 10 which extends axially from a seal portion 12. The seal portion 12 has a larger cross-sectional area than the connecting portion 10. A first sealing surface 14 is configured on the seal portion 12. The first sealing surface 14 is embodied as an O-ring. The O-ring is arranged in a circumferential groove of the seal portion 12.

The connecting portion 10 comprises three protrusions 16. The protrusions 16 are embodied as pressing ramps 16 which are formed correspondingly to the cutouts 4. The protrusions 16 have a larger cross section than the counter portions 6 of the wall element 1. Here, the protrusions 16 have a smaller cross section than the cutouts 4, as a result of which the connecting portion 10 can be inserted into the opening when aligned correctly. Each pressing ramp 16 comprises a latching element 18. The latching elements 18 make it possible to avoid unintentional loosening of the connecting element 8. After the connecting element 8 has been rotated in relation to the wall element 1, the protrusions 16 and the counter portions 6 are oriented so as to be overlaid, as a result of which it is no longer possible to separate the connecting element 8 from the wall element 1.

A circumferentially encircling second sealing surface 22 is arranged at an end 20 of the connecting element 8, said end lying opposite the connecting portion 10. The second sealing surface 22 is embodied as a protrusion and forms, according to the embodiment, a so-called VDA connector. By way of example, a hose or a fluid line (not illustrated) can be pushed over the second sealing surface 22.

The connecting element 8 comprises an inner region 24 for guiding a fluid. The inner region 24 has an inner profile 26 of polygonal form.

FIG. 3 illustrates a tool 28 for assembling the connecting element 8 on the wall element 1. According to the embodiment, the tool 28 is configured as a hand tool and comprises a handle 30 and a tool head 32. The tool head 32 is configured in such a way that it can project into the inner region 24 of the connecting element 8. In particular, the connecting element 8 can be arranged on the tool head 32 in order to carry out an assembly operation. As a result of the inner profile 26, the connecting element 8 can be positioned on the tool 28 in a rotationally secure manner. In this way, a rotational movement of the tool 28 can be transmitted directly to the connecting element 8.

According to an embodiment, the tool 28 can be an automated tool which is arranged, for example, on a manipulator arm or on an assembly robot.

FIG. 4 illustrates a connecting arrangement 34 in a schematic sectional illustration. The connecting arrangement 34 comprises a wall element 1 with a connecting element 8 in an inserted state. In the inserted state, the connecting element 8 is rotated relative to the wall element 1 and thus locked on the wall element 1. As a result of the interaction of the counter portions 6 with the pressing ramps 16, a pressing force which is directed axially in the direction of the axis of symmetry S is produced on the first sealing surface 14. In this way, the O-ring 14 is compressed between the seal portion 12 and the wall element 1, as a result of which a fluid-tight coupling is produced.

The connecting element 8 comprises a second sealing surface 22 which is embodied in accordance with a so-called SAE 18 connection system.

According to the embodiment, the opening 2 of the wall element 1 and the pressing ramps 16 of the connecting portion 10 form a bayonet closure, which can be locked in a releasable manner as a result of a plug-and-twist movement.

FIG. 5 shows perspective illustrations of connecting elements 8 according to the disclosure according to further embodiments. Possible configurations of the second sealing surface 22 are illustrated. FIG. 5a illustrates a connecting element 8 with a so-called NQ-PS3 connection system as a second sealing surface 22. FIG. 5b shows a connecting element 8 having a second sealing surface 22 which is designed for connection of a so-called NQ-V2 connection system.

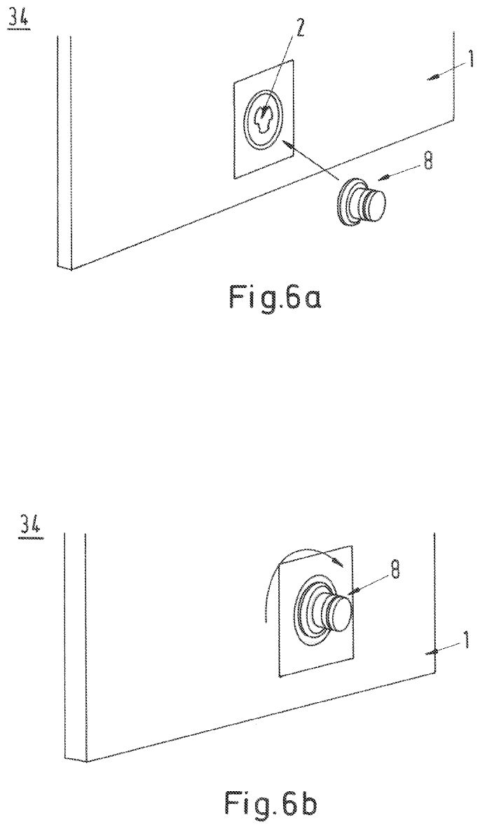

FIG. 6a and FIG. 6b show illustrations of connecting arrangements 34 in order to illustrate the method according to an embodiment of the disclosure. Here, the arrows illustrate the possible movement sequences.

In a first step of the method, the connecting element 8 is arranged on a tool head 32 and placed into the opening 2 of the wall element 1.

In a further step, the tool 28 is rotated clockwise. As a result of the inner profile 26 of the connecting element 8, the rotational movement of the tool 28 can be transmitted directly to the connecting element 8, as a result of which the connecting element 8 is latched, and thus locked, to the wall element 1.

The invention is not restricted to one of the above-described embodiments, but can be modified in many ways.

By way of example, the connecting element 8 can be of one-part or multi-part design. The connecting element 8 and the wall element 1 can be composed of a plastic or a metal.

The method according to embodiments of the invention can be performed in an automated manner or manually in order to carry out the assembly operation.

All of the features and advantages, including structural details, spatial arrangements and method steps, arising from the claims, the description and the drawing may be essential to the invention, both individually and in the various combinations.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE DESIGNATIONS

1 Wall element
2 Opening
4 Cutout
6 Counter portion
8 Connecting element
10 Connecting portion
12 Seal portion
14 First sealing surface
16 Pressing ramp/protrusion
18 Latching element
20 End portion of the connecting element
22 Second sealing surface
24 Inner region of the connecting element
26 Inner profile of the connecting element
28 Tool
30 Handle of the tool
32 Tool head
34 Connecting arrangement
S Axis of symmetry

1. A connecting arrangement for forming a fluid-conducting connection between a container and a fluid line, comprising:
a wall element, which can be arranged in or on a container wall of the container and which has an opening, and
comprising a connecting element having two sealing surfaces, the connecting element comprising, at an end side, a seal portion which is arranged circumferentially on the connecting element and which comprises an axially oriented first sealing surface, and the connecting element comprising, at an end opposite the seal portion, a circumferential second sealing surface, wherein the connecting element comprises, in the region of the first sealing surface, a connecting portion for insertion into the opening of the wall element and for connection to the wall element.

2. The connecting arrangement as claimed in claim 1, wherein the connecting portion is able to be connected to the wall element in a positively locking or force-fitting manner.

3. The connecting arrangement as claimed in claim 1, wherein the connecting portion of the connecting element and the opening of the wall element being designed as a bayonet closure.

4. The connecting arrangement as claimed in claim 3, wherein the opening of the wall element comprising at least one cutout for receiving at least one protrusion of the connecting portion, and the connecting element being able to be locked on the wall element in a releasable or non-releasable manner as a result of a rotation of the connecting element in relation to the wall element along an axis of symmetry (S).

5. The connecting arrangement as claimed in claim 1, wherein, in the connected state, a fluid-tight sealing zone can be formed between the seal portion of the connecting element and the wall element.

6. The connecting arrangement as claimed in claim 1, wherein the second sealing surface being configured to receive a fluid line.

7. The connecting arrangement as claimed in claim 1, wherein the container being a tank, a vessel, a room or at least one region of a vehicle body.

8. The connecting arrangement as claimed in claim 1, wherein the second sealing surface being formed as an SAE connection, a VDA connection, a hose connector or a V2 connection.

9. The connecting arrangement as claimed in claim 1, wherein the connecting portion of the connecting element comprising at least one latching element for forming a latching connection to the wall element.

10. The connecting arrangement as claimed in claim 1, wherein the tubular connecting element having an inner profile for receiving a tool head in a rotationally secure manner.

11. The connecting arrangement as claimed in claim 1, wherein the wall element being able to be recessed into a container wall of the container, as a portion of the container wall or being able to be connected to the container wall in a materially bonded manner.

12. A method for a fluid-conducting connection of a connecting element to a wall element, the method comprising:
arranging a tool head of a tool in an inner region of the connecting element in a rotationally secure manner,
using the tool head to arrange the connecting element in an opening of the wall element in such a way that a connecting portion of the connecting element projects through the opening, and
rotating the connecting element as a result of a rotational movement of the tool head relative to the wall element and being locked on the wall element.
